(19) United States
(12) Patent Application Publication
(10) Pub. No.: US 2014/0309339 A1
(43) Pub. Date: Oct. 16, 2014

(54) Mixtures Of Diphosphinic Acids And Alkylphosphinic Acids, A Process For The Preparation Thereof And The Use Thereof

(71) Applicants: Fabian Schneider, Koeln (DE); Frank Osterod, Koeln (DE); Harald Bauer, Kerpen (DE); Martin Sicken, Koeln (DE)

(72) Inventors: Fabian Schneider, Koeln (DE); Frank Osterod, Koeln (DE); Harald Bauer, Kerpen (DE); Martin Sicken, Koeln (DE)

(73) Assignee: CLARIANT FINANCE (BVI) LIMITED, Tortola (VG)

(21) Appl. No.: 14/364,827

(22) PCT Filed: Dec. 8, 2012
(86) PCT No.: PCT/EP2012/005077

§ 371 Date: Jun. 12, 2014

(30) Foreign Application Priority Data
Dec. 16, 2011 (DE) 10 2011 121 504.6

(51) Int. Cl. C08K 5/5317; C09K 21/12; C08K 5/5313

(52) U.S. Cl. CPC C08K 5/5317; C08K 5/5313; C09K 21/12
USPC 523/451; 252/609; 252/607

(57) ABSTRACT

Mixtures of diphosphinic acids and alkylphosphonic acids, a process for preparation thereof and use thereof.

The invention relates to mixtures of at least one diphosphinic acid of the formula (I)

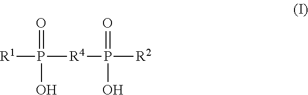

in which
R¹, R² are each H, C₁-C₁₈-alkyl, C₂-C₁₈-alkenyl, C₆-C₁₈-aryl, C₇-C₁₈-alkylaryl
R⁴ is C₁-C₁₈-alkylene, C₂-C₁₈-alkenylene, C₆-C₁₈-arylene, C₇-C₁₈-alkylarylene with at least one alkylphosphonic acid of the formula (II)

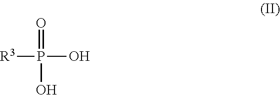

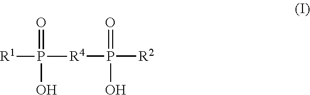

in which
R³ is H, C₁-C₁₈-alkyl, C₂-C₁₈-alkenyl, C₆-C₁₈-aryl and/or C₇-C₁₈-alkylaryl; a process for preparation thereof and use thereof.

The invention relates to mixtures of at least one diphosphinic acid and at least one alkylphosphonic acid, to a process for preparation thereof and to the use thereof.

In the production of printed circuit boards, which are being used to an increasing degree in various devices, for example computers, cameras, cellphones, LCD and TFT screens and other electronic devices, different materials, especially polymers, are being used. These include particularly thermosets, glass fiber-reinforced thermosets and thermoplastics. Owing to their good properties, epoxy resins are used particularly frequently.

According to the relevant standards (IPC-4101, Specification for Base Materials for Rigid and Multilayer Printed Boards), these printed circuit boards must be rendered flame-retardant.

The thermal expansion of printed circuit boards in the course of production thereof is a problem. The conditions of electronics manufacture for printed circuit boards require that printed circuit boards withstand high thermal stresses without damage or deformation. The application of conductor tracks (lead-free soldering) to printed circuit boards is effected at temperatures up to about 260° C.

It is therefore important that printed circuit boards do not warp under thermal stress and the products remain dimensionally stable.

Thermal expansion is significant particularly even in the case of prepregs (short form of “preimpregnated fibers”) and laminates, since these constitute the initial forms or precursors of printed circuit boards.

It is thus important to minimize the thermal expansion of test specimens in order to obtain a good, dimensionally stable product (finished printed circuit board).

It is an object of the present invention to modify polymers for prepregs, printed circuit boards and laminates such that they are subject only to very low thermal expansion—if any at all—and the necessary dimensional stability is fulfilled.

This object is achieved by mixtures of at least one diphosphinic acid of the formula (I)

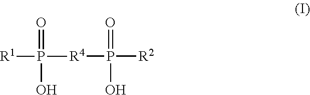

in which
R¹, R² are each H, C₁-C₁₈-alkyl, C₂-C₁₈-alkenyl, C₆-C₁₈-aryl, C₇-C₁₈-alkylaryl
R⁴ is C₁-C₁₈-alkylene, C₂-C₁₈-alkenylene, C₆-C₁₈-arylene, C₇-C₁₈-alkylarylene with at least one alkylphosphonic acid of the formula (II)

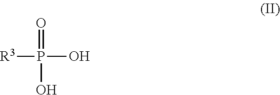

in which
R³ is H, C₁-C₁₈-alkyl, C₂-C₁₈-alkenyl, C₆-C₁₈-aryl and/or C₇-C₁₈-alkylaryl.

Preferably, R¹, R² and R³ are the same or different and are each H, methyl, ethyl, n-propyl, isopropyl, n-butyl, isobutyl, tert-butyl, n-pentyl, isopentyl, n-hexyl, isohexyl and/or phenyl, and R⁴ is ethylene, butylene, hexylene or octylene.

The mixtures preferably comprise 0.1 to 99.9% by weight of diphosphinic acid of the formula (I) and 99.9 to 0.1% by weight of alkylphosphonic acid of the formula (II).

The mixtures more preferably comprise 40 to 99.9% by weight of diphosphinic acid of the formula (I) and 60 to 0.1% by weight of alkylphosphonic acid of the formula (II). Preference is likewise given to mixtures comprising 60 to 99.9% by weight of diphosphinic acid of the formula (I) and 40 to 0.1% by weight of alkylphosphonic acid of the formula (II).

More particularly, the mixtures comprise 80 to 99.9% by weight of diphosphinic acid of the formula (I) and 20 to 0.1% by weight of alkylphosphonic acid of the formula (II).

In another embodiment, the mixtures comprise 90 to 99.9% by weight of diphosphinic acid of the formula (I) and 10 to 0.1% by weight of alkylphosphonic acid of the formula (II).

In a further embodiment, the mixtures comprise 95 to 99.9% by weight of diphosphinic acid of the formula (I) and 5 to 0.1% by weight of alkylphosphonic acid of the formula (II).

For many applications, preference is given to mixtures comprising 98 to 99.9% by weight of diphosphinic acid of the formula (I) and 2 to 0.1% by weight of alkylphosphonic acid of the formula (II).

For the present invention, particular preference is given to mixtures comprising 98 to 99.9% by weight of ethylene-1,2-bis(ethylphosphinic acid) and 2 to 0.1% by weight of ethylphosphonic acid.

The invention relates preferably to mixtures of the aforementioned type in which the diphosphinic acid is ethylene-1,2-bis(ethylphosphinic acid), ethylene-1,2-bis(propylphosphinic acid), ethylene-1,2-bis(butylphosphinic acid), ethylene-1,2-bis(pentylphosphinic acid), ethylene-1,2-bis(hexylphosphinic acid), butylene-1,2-bis(ethylphosphinic acid), butylene-1,2-bis(propylphosphinic acid), butylene-1,2-bis(butylphosphinic acid), butylene-1,2-bis(pentylphosphinic acid), butylene-1,2-bis(hexylphosphinic acid), hexylene-1,2-bis(ethylphosphinic acid), hexylene-1,2-bis(propylphosphinic acid), hexylene-1,2-bis(butylphosphinic acid), hexylene-1,2-bis(pentylphosphinic acid) or hexylene-1,2-bis(hexylphosphinic acid) and the alkylphosphonic acid is ethylphosphonic acid, propylphosphonic acid, butylphosphonic acid, pentylphosphonic acid or hexylphosphonic acid.

The mixtures preferably further comprise at least one synergist.

The synergist is preferably a nitrogen-containing compound such as melem, melam, melon, melamine borate, melamine cyanurate, melamine phosphate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphate, melam polyphosphate, melem polyphosphate and/or melon polyphosphate.

The synergist preferably also comprises aluminum compounds, magnesium compounds, tin compounds, antimony compounds, zinc compounds, silicon compounds, phosphorus compounds, carbodiimides, phosphazenes, piperazines, piperazine (pyro)phosphates, (poly)isocyanates and/or styrene-acrylic polymers.

More particularly, the synergist comprises aluminum hydroxide, halloysites, sapphire products, boehmite, nanoboehmite; magnesium hydroxide; antimony oxides; tin oxides; zinc oxide, zinc hydroxide, zinc oxide hydrate, zinc carbonate, zinc stannate, zinc hydroxystannate, zinc silicate, zinc phosphate, zinc borophosphate, zinc borate and/or zinc molybdate; phosphinic acids and salts thereof, phosphonic acids and salts thereof and/or phosphine oxides; carbonylbiscaprolactam.

In addition, the synergist preferably comprises nitrogen compounds from the group of oligomeric esters of tris(hydroxyethyl)isocyanurate with aromatic polycarboxylic acids, or benzoguanamine, acetoguanamine, tris(hydroxyethyl)isocyanurate, allantoin, glycoluril, cyanurates, cyanurate-epoxide compounds, urea cyanurate, dicyanamide, guanidine, guanidine phosphate and/or sulfate.

The mixtures preferably comprise 99 to 1% by weight of the mixture of at least one diphosphinic acid of the formula (I) and at least one alkylphosphonic acid of the formula (II) as claimed in at least one of claims 1 to 11 and 1 to 99% by weight of synergist.

The invention also relates to a process for preparing the mixtures as claimed in at least one of claims 1 to 11, which comprises reacting a phosphinic acid source with an alkyne in the presence of an initiator.

Preferably, the phosphinic acid source is ethylphosphinic acid and the alkyne is acetylene, methylacetylene, 1-butyne, 1-hexyne, 2-hexyne, 1-octyne, 4-octyne, 1-butyn-4-ol, 2-butyn-1-ol, 3-butyn-1-ol, 5-hexyn-1-ol, 1-octyn-3-ol, 1-pentyne, phenylacetylene, trimethylsilylacetylene and/or diphenylacetylene.

The initiator is preferably a free-radical initiator having a nitrogen-nitrogen or an oxygen-oxygen bond.

The free-radical initiator is more preferably 2,2′-azobis(2-amidinopropane) dihydrochloride, 2,2′-azobis(N,N′-dimethyleneisobutyramidine)dihydrochloride, azobis(isobutyronitrile), 4,4′-azobis(4-cyanopentanoic acid) and/or 2,2′-azobis(2-methylbutyronitrile) or hydrogen peroxide, ammonium peroxodisulfate, potassium peroxodisulfate, dibenzoyl peroxide, di-tert-butyl peroxide, peracetic acid, diisobutyryl peroxide, cumene peroxyneodecanoate, tert-butyl peroxyneodecanoate, tert-butyl peroxypivalate, tert-amyl peroxypivalate, dipropyl peroxydicarbonate, dibutyl peroxydicarbonate, dimyristyl peroxydicarbonate, dilauroyl peroxide, 1,1,3,3-tetramethylbutyl peroxy-2-ethylhexanoate, tert-amyl peroxy-2-ethylhexylcarbonate, tert-butyl peroxyisobutyrate, 1,1-di(tert-butylperoxy)cyclohexane, tert-butyl peroxybenzoate, tert-butyl peroxyacetate, tert-butyl peroxydiethylacetate, tert-butyl peroxyisopropylcarbonate, 2,2-di(tert-butylperoxy)butane, tert-amyl hydroperoxide and/or 2,5-dimethyl-2,5-di(tert-butylperoxy)hexane.

The solvent preferably comprises straight-chain or branched alkanes, alkyl-substituted aromatic solvents, water-immiscible or only partly water-miscible alcohols or ethers, water and/or acetic acid.

The alcohol is preferably methanol, propanol, i-butanol and/or n-butanol or comprises mixtures of these alcohols with water.

The reaction temperature is preferably 50 to 150° C.

The invention also relates to the use of mixtures of at least one diphosphinic acid of the formula (I) and at least one alkylphosphonic acid of the formula (II) as claimed in at least one of claims 1 to 11 as an intermediate for further syntheses, as a binder, as a crosslinker or accelerator in the curing of epoxy resins, polyurethanes and unsaturated polyester resins, as polymer stabilizers, as crop protection compositions, as sequestrants, as a mineral oil additive, as an anticorrosive, in washing and cleaning composition applications and in electronics applications.

The invention additionally relates to the use of mixtures of at least one diphosphinic acid of the formula (I) and at least one alkylphosphonic acid of the formula (II) as claimed in at least one of claims 1 to 13 as a flame retardant, especially as a flame retardant for clearcoats and intumescent coatings, as a flame retardant for wood and other cellulosic products, as a reactive and/or nonreactive flame retardant for polymers, for production of flame-retardant polymer molding compositions, for production of flame-retardant polymer moldings and/or for rendering polyester and pure and blended cellulose fabrics flame-retardant by impregnation, and as a synergist.

The invention also encompasses flame-retardant thermoplastic or thermoset polymer molding compositions, moldings, films, filaments and fibers comprising 0.5 to 99.5% by weight of mixtures as claimed in at least one of claims 1 to 13, 0.5 to 99.5% by weight of thermoplastic or thermoset polymer or mixtures thereof, 0 to 55% by weight of additives and 0 to 55% by weight of filler or reinforcing materials, where the sum of the components is 100% by weight.

The invention finally relates to flame-retardant thermoplastic or thermoset polymer molding compositions, moldings, films, filaments and fibers comprising 1 to 30% by weight of mixtures as claimed in at least one of claims 1 to 13, 10 to 95% by weight of thermoplastic or thermoset polymer or mixtures thereof, 2 to 30% by weight of additives and 2 to 30% by weight of filler or reinforcing materials, where the sum of the components is 100% by weight.

Preferably, R¹ and R² are the same or different and are each H, methyl, ethyl, n-propyl, isopropyl, n-butyl, isobutyl, tert-butyl, n-pentyl, isopentyl, n-hexyl, isohexyl and/or phenyl; R³ is (independently of R¹ and R²) preferably methyl, ethyl, n-propyl, isopropyl, n-butyl, isobutyl, tert-butyl, n-pentyl, isopentyl, n-hexyl, isohexyl and/or phenyl, and R⁴ is ethylene, butylene, hexylene or octylene; this means the C₂, C₄, C₆ or C₈ group which connects the two phosphorus atoms.

Preference is also given to mixtures comprising 98 to 99.9% by weight of ethylene-1,2-bis(ethylphosphinic acid) and 2 to 0.1% by weight of ethylphosphonic acid.

Preferred two-component mixtures of at least one diphosphinic acid of the formula (I) and at least one alkylphosphonic acid of the formula (II) are composed of ethylene-1,2-bis(ethylphosphinic acid) and ethylphosphonic acid, ethylene-1,2-bis(ethylphosphinic acid) and propylphosphonic acid, ethylene-1,2-bis(ethylphosphinic acid) and butylphosphonic acid, ethylene-1,2-bis(ethylphosphinic acid) and pentylphosphonic acid, ethylene-1,2-bis(ethylphosphinic acid) and hexylphosphonic acid, ethylene-1,2-bis(propylphosphinic acid) and ethylphosphonic acid, ethylene-1,2-bis(propylphosphinic acid) and propylphosphonic acid, ethylene-1,2-bis(propylphosphinic acid) and butylphosphonic acid, ethylene-1,2-bis(propylphosphinic acid) and pentylphosphonic acid, ethylene-1,2-bis(propylphosphinic acid) and hexylphosphonic acid, ethylene-1,2-bis(butylphosphinic acid) and ethylphosphonic acid, ethylene-1,2-bis(butylphosphinic acid) and propylphosphonic acid, ethylene-1,2-bis(butylphosphinic acid) and butylphosphonic acid, ethylene-1,2-bis(butylphosphinic acid) and pentylphosphonic acid, ethylene-1,2-bis(butylphosphinic acid) and hexylphosphonic acid, ethylene-1,2-bis(pentylphosphinic acid) and ethylphosphonic acid, ethylene-1,2-bis(pentylphosphinic acid) and propylphosphonic acid, ethylene-1,2-bis(pentylphosphinic acid) and butylphosphonic acid, ethylene-1,2-bis(pentylphosphinic acid) and pentylphosphonic acid, ethylene-1,2-bis(pentylphosphinic acid) and hexylphosphonic acid, ethylene-1,2-bis(hexylphosphinic acid) and ethylphosphonic acid, ethylene-1,2-bis(hexylphosphinic acid) and propylphosphonic acid, ethylene-1,2-bis(hexylphosphinic acid) and butylphosphonic acid, ethylene-1,2-bis(hexylphosphinic acid) and pentylphosphonic acid, ethylene-1,2-bis(hexylphosphinic acid) and hexylphosphonic acid, butylene-1,2-bis(ethylphosphinic acid) and ethylphosphonic acid, butylene-1,2-bis(ethylphosphinic acid) and propylphosphonic acid, butylene-1,2-bis(ethylphosphinic acid) and butylphosphonic acid, butylene-1,2-bis(ethylphosphinic acid) and pentylphosphonic acid, butylene-1,2-bis(ethylphosphinic acid) and hexylphosphonic acid, butylene-1,2-bis(propylphosphinic acid) and ethylphosphonic acid, butylene-1,2-bis(propylphosphinic acid) and propylphosphonic acid, butylene-1,2-bis(propylphosphinic acid) and butylphosphonic acid, butylene-1,2-bis(propylphosphinic acid) and pentylphosphonic acid butylene-1,2-bis(propylphosphinic acid) and hexylphosphonic acid, butylene-1,2-bis(butylphosphinic acid) and ethylphosphonic acid, butylene-1,2-bis(butylphosphinic acid) and propylphosphonic acid, butylene-1,2-bis(butylphosphinic acid) and butylphosphonic acid, butylene-1,2-bis(butylphosphinic acid) and pentylphosphonic acid, butylene-1,2-bis(butylphosphinic acid) and hexylphosphonic acid, butylene-1,2-bis(pentylphosphinic acid) and ethylphosphonic acid, butylene-1,2-bis(pentylphosphinic acid) and propylphosphonic acid, butylene-1,2-bis(pentylphosphinic acid) and butylphosphonic acid, butylene-1,2-bis(pentylphosphinic acid) and pentylphosphonic acid, butylene-1,2-bis(pentylphosphinic acid) and hexylphosphonic acid, butylene-1,2-bis(hexylphosphinic acid) and ethylphosphonic acid, butylene-1,2-bis(hexylphosphinic acid) and propylphosphonic acid, butylene-1,2-bis(hexylphosphinic acid) and butylphosphonic acid, butylene-1,2-bis(hexylphosphinic acid) and pentylphosphonic acid, butylene-1,2-bis(hexylphosphinic acid) and hexylphosphonic acid, hexylene-1,2-bis(ethylphosphinic acid) and ethylphosphonic acid, hexylene-1,2-bis(ethylphosphinic acid) and propylphosphonic acid, hexylene-1,2-bis(ethylphosphinic acid) and butylphosphonic acid, hexylene-1,2-bis(ethylphosphinic acid) and pentylphosphonic acid, hexylene-1,2-bis(ethylphosphinic acid) and hexylphosphonic acid, hexylene-1,2-bis(propylphosphinic acid) and ethylphosphonic acid, hexylene-1,2-bis(propylphosphinic acid) and propylphosphonic acid, hexylene-1,2-bis(propylphosphinic acid) and butylphosphonic acid, hexylene-1,2-bis(propylphosphinic acid) and pentylphosphonic acid, hexylene-1,2-bis(propylphosphinic acid) and hexylphosphonic acid, hexylene-1,2-bis(butylphosphinic acid) and ethylphosphonic acid, hexylene-1,2-bis(butylphosphinic acid) and propylphosphonic acid, hexylene-1,2-bis(butylphosphinic acid) and butylphosphonic acid, hexylene-1,2-bis(butylphosphinic acid) and pentylphosphonic acid, hexylene-1,2-bis(butylphosphinic acid) and hexylphosphonic acid, hexylene-1,2-bis(pentylphosphinic acid) and ethylphosphonic acid, hexylene-1,2-bis(pentylphosphinic acid) and propylphosphonic acid, hexylene-1,2-bis(pentylphosphinic acid) and butylphosphonic acid, hexylene-1,2-bis(pentylphosphinic acid) and pentylphosphonic acid, hexylene-1,2-bis(pentylphosphinic acid) and hexylphosphonic acid, hexylene-1,2-bis(hexylphosphinic acid) and ethylphosphonic acid, hexylene-1,2-bis(hexylphosphinic acid) and propylphosphonic acid, hexylene-1,2-bis(hexylphosphinic acid) and butylphosphonic acid, hexylene-1,2-bis(hexylphosphinic acid) and pentylphosphonic acid, hexylene-1,2-bis(hexylphosphinic acid) and hexylphosphonic acid.

In addition, multicomponent mixtures may also occur, for example of ethylene-1,2-bis(ethylphosphinic acid), ethylphosphonic acid and butylphosphonic acid or, for instance, of ethylene-1,2-bis(ethylphosphinic acid), ethylene-1,2-bis(butylphosphinic acid), ethylphosphonic acid and butylphosphonic acid etc.

More preferably, R¹, R² and R³ are the same or different and are each ethyl or butyl.

The synergist is preferably an expansion-neutral substance, which means that its dimensions do not change under thermal or similar stress. Such changes can be determined by means of the coefficient of thermal expansion. This describes the changes in the dimensions of a substance in the event of temperature changes.

The mixtures preferably comprise 65 to 1% by weight of the mixture of at least one diphosphinic acid of the formula (I) and at least one alkylphosphonic acid of the formula (II) as claimed in at least one of claims 1 to 11 and 1 to 35% by weight of synergist. The mixtures preferably also comprise 80 to 95% by weight of the mixture of at least one diphosphinic acid of the formula (I) and at least one alkylphosphonic acid of the formula (II) as claimed in at least one of claims 1 to 11 and 5 to 20% by weight of synergist.

In the process according to the invention, a phosphinic acid source is reacted with an alkyne in the presence of an initiator. This typically involves, first of all, reacting an alkene with phosphinic acid to give an alkylphosphinic acid, which is then reacted further with an alkyne to give the inventive mixture.

Preference is given here to reacting phosphinic acid itself with ethylene in the presence of a (metallocene) catalyst to give ethylphosphinic acid and reacting the latter, after purification, with acetylene in the presence of an initiator to give the inventive mixture of a diphosphinic acid of the formula (I) with at least one alkylphosphonic acid of the formula (II).

Preference is given to processing the inventive mixture of at least one diphosphinic acid of the formula (I) and at least one alkylphosphonic acid of the formula (II) by mixing it into a polymer system.

The mixing is effected typically by kneading, dispersing and/or extruding.

Preference is given to using the inventive mixture of at least one diphosphinic acid of the formula (I) and at least one alkylphosphonic acid of the formula (II) by additive incorporation into a polymer system.

Particular preference is given to using the inventive mixture of at least one diphosphinic acid of the formula (I) and at least one alkylphosphonic acid of the formula (II) by reactive incorporation into a polymer system. Reactive incorporation is characterized by a resulting permanent bond to the polymer extrudates of the polymer system, as a result of which the inventive mixture of at least one diphosphinic acid of the formula (I) and at least one alkylphosphonic acid of the formula (II) cannot be leached out.

The inventive mixtures can be used together with further flame retardants and further synergists. The further flame retardants include, for example, phosphorus compounds such as phosphinates, phosphonates, phosphates, phosphonic acids, phosphinic acids, phosphoric acids, phosphines, phosphine oxides, phosphorus oxides and others.

Suitable polymer additives for flame-retardant polymer molding compositions and polymer moldings are UV absorbers, light stabilizers, lubricants, colorants, antistats, nucleating agents, fillers, synergists, reinforcers and others.

The polymer systems preferably originate from the group of the thermoplastic polymers such as polyamide, polyester or polystyrene and/or thermoset polymers.

The thermoset polymers are preferably epoxy resins.

The thermoset polymers are preferably epoxy resins which have been cured with phenols and/or dicyandiamide [more generally: phenol derivatives (resols); alcohols and amines], especially phenol derivatives and dicyandiamide.

The thermoset polymers are more preferably epoxy resins which have been cured with phenols and/or dicyandiamide and/or a catalyst.

The catalysts are preferably imidazole compounds.

The epoxy resins are preferably polyepoxide compounds.

The epoxy resins are preferably resins based on novolac and/or bisphenol A. The polymers are preferably polymers of mono- and diolefins, for example polypropylene, polyisobutylene, polybutene-1, poly-4-methylpentene-1, polyisoprene or polybutadiene, and addition polymers of cycloolefins, for example of cyclopentene or norbornene; and also polyethylene (which may optionally be crosslinked), e.g. high-density polyethylene (HDPE), high-density high-molar mass polyethylene (HDPE-HMW), high-density ultrahigh-molar mass polyethylene (HDPE-UHMW), medium-density polyethylene (MDPE), low-density polyethylene (LDPE), linear low-density polyethylene (LLDPE), branched low-density polyethylene (BLDPE), and mixtures thereof.

The polymers are preferably copolymers of mono- and diolefins with one another or with other vinyl monomers, for example ethylene-propylene copolymers, linear low-density polyethylene (LLDPE) and mixtures thereof with low-density polyethylene (LDPE), propylene-butene-1 copolymers, propylene-isobutylene copolymers, ethylene-butene-1 copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers thereof with carbon monoxide, or ethylene-acrylic acid copolymers and salts thereof (ionomers), and also terpolymers of ethylene with propylene and a diene such as hexadiene, dicyclopentadiene or ethylidenenorbornene; and also mixtures of such copolymers with one another, e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers and alternating or random polyalkylene/carbon monoxide copolymers and mixtures thereof with other polymers, for example polyamides.

The polymers are preferably hydrocarbon resins (e.g. C₅C₉), including hydrogenated modifications thereof (e.g. tackifier resins) and mixtures of polyalkylenes and starch.

The polymers are preferably polystyrene (Polystyrol® 143E (BASF), poly(p-methylstyrene), poly(alpha-methylstyrene). The polymers are preferably copolymers of styrene or alpha-methylstyrene with dienes or acrylic derivatives, for example styrene-butadiene, styrene-acrylonitrile, styrene-alkyl methacrylate, styrene-butadiene-alkyl acrylate and methacrylate, styrene-maleic anhydride, styrene-acrylonitrile-methyl acrylate; more impact-resistant mixtures of styrene copolymers and another polymer, for example a polyacrylate, a diene polymer or an ethylene-propylene-diene terpolymer; and block copolymers of styrene, for example styrene-butadiene-styrene, styrene-isoprene-styrene, styrene-ethylene/butylene-styrene or styrene-ethylene/propylene-styrene.

The polymers are preferably also graft copolymers of styrene or alpha-methylstyrene, for example styrene onto polybutadiene, styrene onto polybutadiene-styrene or polybutadiene-acrylonitrile copolymers, styrene and acrylonitrile (or methacrylonitrile) onto polybutadiene; styrene, acrylonitrile and methyl methacrylate onto polybutadiene; styrene and maleic anhydride onto polybutadiene; styrene, acrylonitrile and maleic anhydride or maleimide onto polybutadiene; styrene and maleimide onto polybutadiene, styrene and alkyl acrylates or alkyl methacrylates onto polybutadiene, styrene and acrylonitrile onto ethylene-propylene-diene terpolymers, styrene and acrylonitrile onto polyalkyl acrylates or polyalkyl methacrylates, styrene and acrylonitrile onto acrylate-butadiene copolymers, and mixtures thereof, as known, for example, as ABS, MBS, ASA or AES polymers.

The styrene polymers are preferably comparatively coarse-pore foam such as EPS (expanded polystyrene), e.g. Styropor (BASF) and/or foam with relatively fine pores such as XPS (extruded rigid polystyrene foam), e.g. Styrodur® (BASF). Preference is given to polystyrene foams, for example Austrotherm® XPS, Styrofoam® (Dow Chemical), Floormate®, Jackodur®, Lustron®, Roofmate®, Sagex® and Telgopor®.

The polymers are preferably halogenated polymers, for example polychloroprene, chlorine rubber, chlorinated and brominated copolymer of isobutylene-isoprene (halobutyl rubber), chlorinated or chlorosulfonated polyethylene, copolymers of ethylene and chlorinated ethylene, epichlorohydrin homo- and copolymers, especially polymers of halogenated vinyl compounds, for example polyvinyl chloride, polyvinylidene chloride, polyvinyl fluoride, polyvinylidene fluoride; and copolymers thereof, such as vinyl chloride-vinylidene chloride, vinyl chloride-vinyl acetate or vinylidene chloride-vinyl acetate.

The polymers are preferably polymers which derive from alpha,beta-unsaturated acids and derivatives thereof, such as polyacrylates and polymethacrylates, polymethyl methacrylates, polyacrylamides and polyacrylonitriles impact-modified with butyl acrylate, and copolymers of the monomers mentioned with one another or with other unsaturated monomers, for example acrylonitrile-butadiene copolymers, acrylonitrile-alkyl acrylate copolymers, acrylonitrile-alkoxyalkyl acrylate copolymers, acrylonitrile-vinyl halide copolymers or acrylonitrile-alkyl methacrylate-butadiene terpolymers.

The polymers are preferably polymers which derive from unsaturated alcohols and amines or the acyl derivatives or acetals thereof, such as polyvinyl alcohol, polyvinyl acetate, stearate, benzoate or maleate, polyvinyl butyral, polyallyl phthalate, polyallylmelamine; and copolymers thereof with olefins.

The polymers are preferably homo- and copolymers of cyclic ethers, such as polyalkylene glycols, polyethylene oxide, polypropylene oxide or copolymers thereof with bisglycidyl ethers.

The polymers are preferably polyacetals such as polyoxymethylene, and those polyoxymethylenes which contain comonomers, for example ethylene oxide; polyacetals which have been modified with thermoplastic polyurethanes, acrylates or MBS.

The polymers are preferably polyphenylene oxides and sulfides and mixtures thereof with styrene polymers or polyamides.

The polymers are preferably polyurethanes which derive from polyethers, polyesters and polybutadienes having both terminal hydroxyl groups and aliphatic or aromatic polyisocyanates, and the precursors thereof.

The polymers are preferably polyamides and copolyamides which derive from diamines and dicarboxylic acids and/or from aminocarboxylic acids or the corresponding lactams, such as nylon 2/12, nylon 4 (poly-4-aminobutyric acid, Nylon® 4, from DuPont), nylon 4/6 (poly(tetramethyleneadipamide)), Nylons 4/6, from DuPont), nylon 6 (polycaprolactam, poly-6-aminohexanoic acid, Nylons 6, from DuPont, Akulon K122, from DSM; Zytel® 7301, from DuPont; Durethan® B 29, from Bayer), nylon 6/6 (poly(N,N′-hexamethyleneadipamide), Nylon® 6/6, from DuPont, Zytel® 101, from DuPont; Durethan A30, Durethan® AKV, Durethan® AM, from Bayer; Ultramid® A3, from BASF), nylon 6/9 (poly(hexamethylenenonanamide), Nylon® 6/9, from DuPont), nylon 6/10 (poly(hexamethylenesebacamide), Nylon® 6/10, from DuPont), nylon 6/12 (poly(hexamethylenedodecanediamide), Nylon® 6/12, from DuPont), nylon 6/66 (poly(hexamethyleneadipamide-co-caprolactam), Nylon® 6/66, from DuPont), nylon 7 (poly-7-aminoheptanoic acid, Nylon® 7, from DuPont), nylon 7,7 (polyheptamethylenepimelamide, Nylon® 7,7, from DuPont), nylon 8 (poly-8-aminooctanoic acid, Nylon® 8, from DuPont), nylon 8,8 (polyoctamethylenesuberamide, Nylon® 8,8, from DuPont), nylon 9 (poly-9-aminononanoic acid, Nylon® 9, from DuPont), nylon 9,9 (polynonamethyleneazelamide, Nylon® 9,9, from DuPont), nylon 10 (poly-10-aminodecanoic acid, Nylon® 10, from DuPont), nylon 10,9 (poly(decamethyleneazelamide), Nylon® 10,9, from DuPont), nylon 10,10 (polydecamethylenesebacamide, Nylon® 10,10, from DuPont), nylon 11 (poly-11-aminoundecanoic acid, Nylon® 11, from DuPont), nylon 12 (polylauryllactam, Nylon® 12, from DuPont, Grillamid® L20, from Ems Chemie), aromatic polyamides proceeding from m-xylene, diamine and adipic acid; polyamides prepared from hexamethylenediamine and iso- and/or terephthalic acid (polyhexamethyleneisophthalamide, polyhexamethyleneterephthalamide) and optionally an elastomer as a modifier, e.g. poly-2,4,4-trimethylhexamethyleneterephthalamide or poly-m-phenyleneisophthalamide. Block copolymers of the aforementioned polyamides with polyolefins, olefin copolymers, ionomers or chemically bonded or grafted elastomers; or with polyethers, for example with polyethylene glycol, polypropylene glycol or polytetramethylene glycol. In addition, polyamides or copolyamides modified with EPDM (ethylene-propylene-diene rubber) or ABS (acrylonitrile-butadiene-styrene); and polyamides condensed during processing (“RIM polyamide systems”). The polymers are preferably polyureas, polybenzimidazoles, polyimides, polyamidimides, polyetherimides, polyesterimides and polyhydantoins. The polymers are preferably polyesters which derive from dicarboxylic acids and dialcohols and/or from hydroxycarboxylic acids or the corresponding lactones, such as polyethylene terephthalate, polybutylene terephthalate (Celanex® 2500, Celanex® 2002, from Celanese; Ultradur®, from BASF), poly-1,4-dimethylolcyclohexane terephthalate, polyhydroxybenzoates, and block polyether esters which derive from polyethers with hydroxyl end groups; and also polyesters modified with polycarbonates or MBS.

The polymers are preferably polycarbonates and polyester carbonates.

The polymers are preferably polysulfones, polyether sulfones and polyether ketones.

Preferably, the polymers are crosslinked polymers which derive from aldehydes on the one hand, and phenols, urea or melamine on the other hand, such as phenol-formaldehyde, urea-formaldehyde and melamine-formaldehyde resins.

The polymers are preferably drying and nondrying alkyd resins.

The polymers are preferably unsaturated polyester resins which derive from copolyesters of saturated and unsaturated dicarboxylic acids with polyhydric alcohols, and vinyl compounds as crosslinking agents, and also the halogenated, low-combustibility modifications thereof.

The polymers are preferably crosslinkable acrylic resins which derive from substituted acrylic esters, for example from epoxy acrylates, urethane acrylates or polyester acrylates.

The polymers are preferably alkyd resins, polyester resins and acrylate resins which have been crosslinked with melamine resins, urea resins, isocyanates, isocyanurates, polyisocyanates or epoxy resins.

The polymers are preferably crosslinked epoxy resins which derive from aliphatic, cycloaliphatic, heterocyclic or aromatic glycidyl compounds, for example products of bisphenol A diglycidyl ethers, bisphenol F diglycidyl ethers, which are crosslinked by means of customary hardeners, for example anhydrides or amines, with or without accelerators.

The polymers are preferably mixtures (polyblends) of the above-mentioned polymers, for example PP/EPDM (polypropylene/ethylene-propylene-diene rubber), polyamide/EPDM or ABS (polyamide/ethylene-propylene-diene rubber or acrylonitrile-butadiene-styrene), PVC/EVA (polyvinyl chloride/ethylene-vinyl acetate), PVC/ABS (polyvinyl chloride/acrylonitrile-butadiene-styrene), PVC/MBS (polyvinyl chloride/methacrylate-butadiene-styrene), PC/ABS (polycarbonate/acrylonitrile-butadiene-styrene), PBTP/ABS (polybutylene terephthalate/acrylonitrile-butadiene-styrene), PC/ASA (polycarbonate/acrylic ester-styrene-acrylonitrile), PC/PBT (polycarbonate/polybutylene terephthalate), PVC/CPE (polyvinyl chloride/chlorinated polyethylene), PVC/acrylate (polyvinyl chloride/acrylate, POM/thermoplastic PUR (polyoxymethylene/thermoplastic polyurethane), PC/thermoplastic PUR (polycarbonate/thermoplastic polyurethane), POM/acrylate (polyoxymethylene/acrylate), POM/MBS (polyoxymethylene/methacrylate-butadiene-styrene), PPO/HIPS (polyphenylene oxide/high-impact polystyrene), PPO/PA 6,6 (polyphenylene oxide/nylon 6,6) and copolymers, PA/HDPE (polyamide/high-density polyethylene), PA/PP (polyamide/polyethylene), PA/PPO (polyamide/polyphenylene oxide), PBT/PC/ABS (polybutylene terephthalate/polycarbonate/acrylonitrile-butadiene-styrene) and/or PBT/PET/PC (polybutylene terephthalate/polyethylene terephthalate/polycarbonate).

The polymers may be laser-markable.

The molding produced is preferably of rectangular shape with a regular or irregular base, or of cubic shape, cuboidal shape, cushion shape or prism shape.

The invention is illustrated by the examples which follow.

Production, Processing and Testing of Flame-Retardant Polymer Molding Compositions and Flame-Retardant Polymer Moldings

The flame-retardant components are mixed with the polymer pellets and any additives and incorporated in a twin-screw extruder (model: Leistritz LSM® 30/34) at temperatures of 230 to 260° C. (PBT-GR) or of 260 to 280° C. (PA 66-GR). The homogenized polymer strand was drawn off, cooled in a water bath and then pelletized.

After sufficient drying, the molding compositions were processed on an injection molding machine (model: Aarburg AlIrounder) at melt temperatures of 240 to 270° C. (PBT-GR) or of 260 to 290° C. (PA 66-GR) to give test specimens. The test specimens are tested for flame retardancy and classified using the UL 94 test (Underwriter Laboratories).

Test specimens of each mixture were used to determine the UL 94 fire class (Underwriter Laboratories) on specimens of thickness 1.5 mm.

The UL 94 fire classifications are as follows:

V-0: afterflame time never longer than 10 sec., total of afterflame times for 10 flame applications not more than 50 sec., no flaming drops, no complete consumption of the specimen, afterglow time for specimens never longer than 30 sec. after end of flame application
V-1: afterflame time never longer than 30 sec. after end of flame application, total of afterflame times for 10 flame applications not more than 250 sec., afterglow time for specimens never longer than 60 sec. after end of flame application, other criteria as for V-0
V-2: cotton indicator ignited by flaming drops, other criteria as for V-1. Not classifiable (ncl): does not fulfill fire class V-2.

For some samples examined, the LOI was also measured. The LOI (Limiting Oxygen Index) is determined to ISO 4589. According to ISO 4589, the LOI corresponds to the lowest oxygen concentration in percent by volume which just still supports the combustion of the polymer in a mixture of oxygen and nitrogen. The higher the LOI the greater the nonflammability of the material tested.

| | | |
|---|---|---|
| LOI | 23 | flammable |
| LOI | 24-28 | limited flammability |
| LOI | 29-35 | flame-retardant |
| LOI | >36 | particularly flame-retardant |

Chemicals and abbreviations used:
Phenol novolac: Bakelite® PF 0790, from Hexion
Initiator: Vazo® 67, from DuPont

In principle, the process according to the invention is executed in such a way that the reaction mixture is exposed only to a relatively low acetylene flow rate of not more than 1 l/h under the given reaction conditions. After the acetylene has been passed through the reaction solution until conversion is adequate and a sufficient time for continued reaction has elapsed, the acetylene feed is stopped and the workup is conducted under oxygen or air. For this purpose, the reaction mixture is ventilated, for example with oxygen, and acetylene is driven out of the apparatus with oxygen, and the product mixture is worked up.

Unless stated otherwise, all amounts are in % by weight.

### EXAMPLE 1

At room temperature, a three-neck flask with stirrer and jacketed coil condenser is initially charged with 5852 g of tetrahydrofuran and “degassed” while stirring and passing nitrogen through, and all further reactions are executed under nitrogen. Then 70 mg of tris(dibenzylideneacetone)dipalladium and 95 mg of 4,5-bis(diphenylphosphino)-9,9-dimethylxanthene are added and the mixture is stirred for a further 15 minutes. While stirring, 198 g of phosphinic acid in 198 g of water are added. The reaction solution is transferred into a 2 l Büchi reactor. While stirring the reaction mixture, the reactor is charged with ethylene to 2.5 bar and the reaction mixture is heated to 80° C. After 56 g of ethylene have been absorbed, the mixture is cooled to room temperature and free ethylene is burnt off.

The reaction mixture is freed from the solvent on a rotary evaporator at a maximum of 60° C. and 350-10 mbar. 300 g of demineralized water are added to the residue, and the mixture is stirred under nitrogen atmosphere at room temperature for 1 hour. The resulting residue is filtered and the filtrate is extracted with 200 ml of toluene. The aqueous phase is freed from the solvent on a rotary evaporator at a maximum of 60° C. and 250-10 mbar.

31P NMR (D₂O, coupled): doublet of multiplet, 36.7 ppm

### EXAMPLE 2

0.5 mol of ethylphosphinic acid from example 1 is initially charged in butanol and inertized while stirring and heated to 80° C. Acetylene is passed through the reaction solution and 0.4 mol-% of initiator is metered in over the course of 3 hours and the mixture is left to react. The acetylene feed is stopped and acetylene is driven out of the apparatus with nitrogen. After the reaction mixture has been cooled, the solid formed is filtered off with suction and redispersed with acetone, washed and dried in a vacuum drying cabinet at 100° C. for 4 hours.

In a yield of 62%, 33.2 g of a mixture of ethylene-1,2-bis(ethylphosphinic acid) (99.9%) and ethylphosphonic acid (0.1%) are obtained.

### EXAMPLE 3

0.5 mol of ethylphosphinic acid from example 1 is initially charged in butanol and inertized while stirring and heated to 80° C. Acetylene is passed through the reaction solution and 0.4 mol-% of initiator is metered in over the course of 2.5 hours and the mixture is left to react. The acetylene feed is stopped and acetylene is driven out of the apparatus with nitrogen. After the reaction mixture has been cooled, the solid formed is filtered off with suction and redispersed with acetone, washed and dried in a vacuum drying cabinet at 100° C. for 4 hours.

In a yield of 68%, 36.3 g of a mixture of ethylene-1,2-bis(ethylphosphinic acid) (98%) and ethylphosphonic acid (2%) are obtained.

### EXAMPLE 4

0.5 mol of ethylphosphinic acid from example 1 is initially charged in butanol and inertized while stirring and heated to 90° C. Acetylene is passed through the reaction solution and 0.5 mol-% of initiator is metered in over the course of 2 hours and the mixture is left to react. The acetylene feed is stopped and acetylene is driven out of the apparatus with nitrogen. After the reaction mixture has been cooled, the solid formed is filtered off with suction and redispersed with acetone, washed and dried in a vacuum drying cabinet at 100° C. for 4 hours.

In a yield of 63%, 33.8 g of a mixture of ethylene-1,2-bis(ethylphosphinic acid) (90%) and ethylphosphonic acid (10%) are obtained.

### EXAMPLE 5

0.5 mol of ethylphosphinic acid from example 1 is initially charged in butanol and inertized while stirring and heated to 100° C. Acetylene is passed through the reaction solution and 0.8 mol-% of initiator is metered in over the course of 2 hours and the mixture is left to react. The acetylene feed is stopped and acetylene is driven out of the apparatus with nitrogen. After the reaction mixture has been cooled, the solid formed is filtered off with suction and redispersed with acetone, washed and dried in a vacuum drying cabinet at 100° C. for 4 hours.

In a yield of 75%, 40.6 g of a mixture of ethylene-1,2-bis(ethylphosphinic acid) (60%) and ethylphosphonic acid (40%) are obtained.

### EXAMPLE 6

0.5 mol of ethylphosphinic acid from example 1 is initially charged in butanol and inertized while stirring and heated to 100° C. Acetylene is passed through the reaction solution and 1.0 mol-% of initiator is metered in over the course of 2 hours and the mixture is left to react. The acetylene feed is stopped and acetylene is driven out of the apparatus with nitrogen. After the reaction mixture has been cooled, the solid formed is filtered off with suction and redispersed with acetone, washed and dried in a vacuum drying cabinet at 100° C. for 4 hours.

In a yield of 71%, 38.5 g of a mixture of ethylene-1,2-bis(ethylphosphinic acid) (50%) and ethylphosphonic acid (50%) are obtained.

### General Method for Producing Polymer Moldings:

### a) Preparation of Phosphorus-Modified Epoxy Resin

A 2 l five-neck flask apparatus is initially charged with 1000 g of the epoxy resin (e.g. Beckopox EP 140). It is heated to 110° C. for one hour and volatile components are removed under reduced pressure.

Thereafter, the reaction mixture is inertized with nitrogen and the temperature in the flask is increased to 170° C. 118 g of the mixture of the phosphorus compounds (selected from examples 2 to 6) are added in each case, while stirring under flowing nitrogen, and an exothermic reaction is observed. The resulting resin is yellow in color and free-flowing.

### b) Production of Epoxy Resin Specimens

100 parts of the phosphorus-modified epoxy resin are mixed with one corresponding OH equivalent of phenol novolac (hydroxide equivalents 105 g/mol, melting point 85-95° C.) and heated to 150° C. This liquefies the components. The mixture is stirred gradually until a homogeneous mixture has formed and is allowed to cool to 130° C. Then 0.03 part 2-phenylimidazole is added and the mixture is stirred once again for 5-10 min. Thereafter, the mixture is poured warm into a dish and cured at 140° C. for 2 h and at 200° C. for 2 h.

### c) Production of Epoxy Resin Laminate

100 parts phosphorus-modified epoxy resin as per b) are added to 63 parts acetone and 27 parts Dowanol® PM, and the appropriate amount of phenol resin is added. The mixture is left to stir for 30 min. and then 2-phenylimidazole is added. Thereafter, the mixture is filtered through a 400 μm sieve in order to remove excess resin particles. Then a woven glass fabric (7628 type, 203 g/m²) was immersed into the solution until complete wetting of the fabric had taken place. The wetted fabric is pulled out of the mixture and excess resin is removed. Thereafter, the wetted fabric is initially cured in stages in a drying cabinet for a brief period at temperatures up to 165° C. and then fully cured in a heated press. The resin content of the cured laminates is 30-50%. The thermal expansion of the molding produced, a laminate, is determined to ASTM E831-06.

### EXAMPLE 7

According to the method for producing a polymer molding, 100% of a bisphenol A resin is used to produce a laminate. This has the values for the coefficient of thermal expansion reported in the table.

### EXAMPLE 8

Pure ethylene-1,2-bis(ethylphosphinic acid) is obtained by washing the product mixture from example 2 repeatedly with acetone until no ethylphosphonic acid is detectable any longer.

According to the general method for producing a polymer molding, a composition composed of 90% bisphenol A resin with hardener and catalyst and 10% ethylene-1,2-bis(ethylphosphinic acid) is then used to produce a molding.

### EXAMPLE 9

According to EP-A-2178891, phosphinic acid by means of catalyst and ethylene are used to obtain ethylphosphinic acid, which is purified by means of esterification and distillation. Subsequent oxidation with oxygen affords pure ethylphosphonic acid.

According to the general method for producing a polymer molding, a composition composed of 90% bisphenol A resin with hardener and catalyst and 10% of the resulting ethylphosphonic acid is then used to produce a molding.

### EXAMPLE 10

According to the general method for producing a polymer molding, a composition composed of 90% of bisphenol A resin with hardener and catalyst and 10% of the inventive mixture of ethylene-1,2-bis(ethylphosphinic acid) and ethylphosphonic acid from example 2 is used to produce a molding.

### EXAMPLE 11

According to the general method for producing a polymer molding, a composition composed of 90% of bisphenol A resin with hardener and catalyst and 10% of the inventive mixture of ethylene-1,2-bis(ethylphosphinic acid) and ethylphosphonic acid from example 3 is used to produce a molding.

### EXAMPLE 12

According to the general method for producing a polymer molding, a composition composed of 90% of bisphenol A resin with hardener and catalyst and 10% of the inventive mixture of ethylene-1,2-bis(ethylphosphinic acid) and ethylphosphonic acid according to example 4 is used to produce a molding.

### EXAMPLE 13

According to the general method for producing a polymer molding, a composition composed of 90% of bisphenol A resin with hardener and catalyst and 10% of the inventive mixture of ethylene-1,2-bis(ethylphosphinic acid) and ethylphosphonic acid from example 5 is used to produce a molding.

### EXAMPLE 14

According to the general method for producing a polymer molding, a composition composed of 90% of bisphenol A resin with hardener and catalyst and 10% of the inventive mixture of ethylene-1,2-bis(ethylphosphinic acid) and ethylphosphonic acid from example 6 is used to produce a molding.

The results are reproduced in the following table:

| | Composition | Ethylene-1,2-bis- | | | |
|---|---|---|---|---|---|
| | of | (ethylphosphinic | | | |
| | polymer | acid)/ | Coefficient of | | |
| | system/ | ethylphosphonic | thermal expansion | | |
| | substance | acid | 0°-100° [ppm/° C.] | | |
| Example | mixture | mixture | Z | X | Y |
| 7 (comp.) | 100:0 | | 69 | 20 | 7 |
| 8 | 90:10 | 100:0 | 68 | 20 | 7 |
| 9 | 90:10 | 0:100 | 70 | 22 | 7 |
| 10 | 90:10 | 99.9:0.1 | 64 | 18 | 5 |
| | | from example 2) | | | |
| 11 | 90:10 | 98:2 | 60 | 16 | 5 |
| | | (from example 3) | | | |
| 12 | 90:10 | 90:10 | 58 | 16 | 5 |
| | | (from example 4) | | | |

The mixtures from examples 5 and 6 likewise give rise to a decrease in the coefficient of thermal expansion.

Compared to the pure laminate (example 7), there is a decrease in the values for the coefficient of thermal expansion of the laminate comprising the inventive mixture of ethylene-1,2-bis(ethylphosphinic acid) and ethylphosphonic acid; thermal expansion is thus very low. An increase in the ethylphosphonic acid content brings about a further improvement. The inventive products lead to lower expansion of the moldings produced and thus meet the demands on dimensional stability.

### EXAMPLE 15

### Production of Polyester-Based Polymer Moldings

### a) Preparation of Phosphorus-Modified Polyethylene Terephthalate

1000 g of dimethyl terephthalate are transesterified with 720 ml of ethylene glycol and 230 mg of Mn(OCOCH₃)₄*4 H₂O at temperatures of 170-220° C. under a nitrogen atmosphere. After the methanol has been separated out, 17.2 g of the inventive mixture from example 4 are added at 220° C. and, after addition of 350 mg of Sb₂O₃, the reaction vessel is heated further to 250° C. and a vacuum is applied simultaneously. The polymerization is effected at 0.2 mm Hg and 287° C. within 2 hours. The resulting product has a melting point of 240-244° C. and a phosphorus content of 0.5%, and is in the form of pellets.

### b) Production of Polymer Moldings

The polymer pellets thus produced are mixed with any additives and they are incorporated in a twin-screw extruder (model: Leistritz LSM 30/34) at temperatures of 250 to 290° C. (PET-GR). The homogenized polymer strand was drawn off, cooled in a water bath and then pelletized.

After sufficient drying, the molding compositions were processed on an injection molding machine (model: Aarburg Allrounder) at melt temperatures of 250 to 300° C. (PET-GR) to give test specimens.

The UL 94 fire class and the LOI were determined on test specimens of thickness 1.6 mm.

Moldings of thickness 1.6 mm result in V-0 and an LOI of 28%.

1. A mixture of at least one diphosphinic acid of the formula (I) 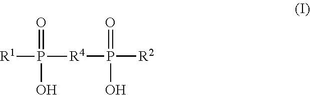
wherein
R¹, R² are H, C₁-C₁₈-alkyl, C₂-C₁₈-alkenyl, C₆-C₁₈-aryl or C₇-C₁₈-alkylaryl
R⁴ is C₁-C₁₈-alkylene, C₂-C₁₈-alkenylene, C₆-C₁₈-arylene or C₇-C₁₈-alkylarylene with at least one alkylphosphonic acid of the formula (II) 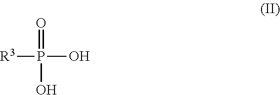
wherein
R³ is H, C₁-C₁₈-alkyl, C₂-C₁₈-alkenyl, C₆-C₁₈-aryl C₇-C₁₈-alkylaryl or mixtures thereof.

2. The mixture as claimed in claim 1, wherein R¹, R² and R³ are the same or different and are H, methyl, ethyl, n-propyl, isopropyl, n-butyl, isobutyl, tert-butyl, n-pentyl, isopentyl, n-hexyl, isohexyl, phenyl or mixtures thereof, and R⁴ is ethylene, butylene, hexylene or octylene.

3. The mixture as claimed in claim 1 comprising 0.1 to 99.9% by weight of diphosphinic acid of the formula (I) and 99.9 to 0.1% by weight of alkylphosphonic acid of the formula (II).

4. The mixture as claimed in claim 1, comprising 40 to 99.9% by weight of diphosphinic acid of the formula (I) and 60 to 0.1% by weight of alkylphosphonic acid of the formula (II).

5. The mixture as claimed in claim 1, comprising 60 to 99.9% by weight of diphosphinic acid of the formula (I) and 40 to 0.1% by weight of alkylphosphonic acid of the formula (II).

6. The mixture as claimed in claim 1, comprising 80 to 99.9% by weight of diphosphinic acid of the formula (I) and 20 to 0.1% by weight of alkylphosphonic acid of the formula (II).

7. The mixture as claimed in claim 1, comprising 90 to 99.9% by weight of diphosphinic acid of the formula (I) and 10 to 0.1% by weight of alkylphosphonic acid of the formula (II).

8. The mixture as claimed in claim 1, comprising 95 to 99.9% by weight of diphosphinic acid of the formula (I) and 5 to 0.1% by weight of alkylphosphonic acid of the formula (II).

9. The mixture as claimed in claim 1, comprising 98 to 99.9% by weight of diphosphinic acid of the formula (I) and 2 to 0.1% by weight of alkylphosphonic acid of the formula (II).

10. The mixture as claimed in claim 1, wherein the diphosphinic acid is ethylene-1,2-bis(ethylphosphinic acid), ethylene-1,2-bis(propylphosphinic acid), ethylene-1,2-bis(butylphosphinic acid), ethylene-1,2-bis(pentylphosphinic acid), ethylene-1,2-bis(hexylphosphinic acid), butylene-1,2-bis(ethylphosphinic acid), butylene-1,2-bis(propylphosphinic acid), butylene-1,2-bis(butylphosphinic acid), butylene-1,2-bis(pentylphosphinic acid), butylene-1,2-bis(hexylphosphinic acid), hexylene-1,2-bis(ethylphosphinic acid), hexylene-1,2-bis(propylphosphinic acid), hexylene-1,2-bis(butylphosphinic acid), hexylene-1,2-bis(pentylphosphinic acid) or hexylene-1,2-bis(hexylphosphinic acid), and the alkylphosphonic acid is ethylphosphonic acid, propylphosphonic acid, butylphosphonic acid, pentylphosphonic acid or hexylphosphonic acid.

11. The mixture as claimed in one or more of claim 10, comprising 98 to 99.9% by weight of ethylene-1,2-bis(ethylphosphinic acid) and 2 to 0.1% by weight of ethylphosphonic acid.

12. The mixture as claimed in claim 1 further comprising at least one synergist, wherein the at one synergist is a nitrogen-containing compound, melem, melam, melon, melamine borate, melamine cyanurate, melamine phosphate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphate, melam polyphosphate, melem polyphosphate, melon polyphosphate;
aluminum compounds, aluminum hydroxide, halloysite, sapphire products, boehmite, nanoboehmite;
magnesium compounds, magnesium hydroxide;
tin compounds, tin oxides;
antimony compounds, antimony oxides;
zinc compounds, zinc oxide, zinc hydroxide, zinc oxide hydrate, zinc carbonate, zinc stannate, zinc hydroxystannate, zinc silicate, zinc phosphate, zinc borophosphate, zinc borate or zinc molybdate;
silicon compounds, silicates silicones;
phosphorus compounds, phosphinic acids and salts thereof, phosphonic acids and salts thereof, phosphine oxides, phosphazenes or piperazine (pyro)phosphates;
carbodiimides, piperazines, (poly)isocyanates, styrene-acrylic polymers; carbonylbiscaprolactam;
nitrogen compounds selected from the group consisting of oligomeric esters of tris(hydroxyethyl) isocyanurate with aromatic polycarboxylic acids, benzoguanamine, acetoguanamine, tris(hydroxyethyl) isocyanurate, allantoin, glycoluril, cyanurates, cyanurate-epoxide compounds, urea cyanurate, dicyanamide, guanidine, guanidine phosphate and sulfate.

13. The mixture as claimed in claim 1, comprising 99 to 1% by weight of a mixture of at least one diphosphinic acid of the formula (I) and at least one alkylphosphonic acid of the formula (II) and 1 to 99% by weight of a synergist.

14. A process for preparing a mixture of at least one diphosphinic acid of the formula (I) 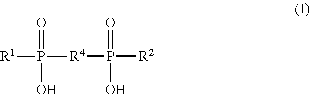
wherein
R¹, R² are H, C₁-C₁₈-alkyl, C₂-C₁₈-alkenyl, C₆-C₁₈-aryl or C₇-C₁₈-alkylaryl
R⁴ is C₁-C₁₈-alkylene, C₂-C₁₈-alkenylene, C₆-C₁₈-arylene or C₇-C₁₈-alkylarylene with at least one alkylphosphonic acid of the formula (II) 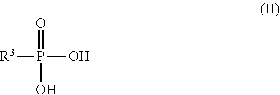
wherein
R³ is H, C₁-C₁₈-alkyl, C₂-C₁₈-alkenyl, C₆-C₁₈-aryl C₇-C₁₈-alkylaryl or mixtures thereof, comprising the step of
reacting a phosphinic acid source with an alkyne in a solvent in the presence of an initiator.

15. The process as claimed in claim 14, wherein the phosphinic acid source is ethylphosphinic acid and the alkyne is acetylene, methylacetylene, 1-butyne, 1-hexyne, 2-hexyne, 1-octyne, 4-octyne, 1-butyn-4-ol, 2-butyn-1-ol, 3-butyn-1-ol, 5-hexyn-1-ol, 1-octyn-3-ol, 1-pentyne, phenylacetylene, trimethylsilylacetylene, diphenylacetylene or mixtures thereof.

16. The process as claimed in claim 14, wherein the initiator is a free-radical initiator having a nitrogen-nitrogen or an oxygen-oxygen bond.

17. The process as claimed in claim 14, wherein the free-radical initiator is 2,2′-azobis(2-amidinopropane)dihydrochloride, 2,2′-azobis(N,N′-dimethyleneisobutyramidine)dihydrochloride, azobis(isobutyronitrile), 4,4′-azobis(4-cyanopentanoic acid), 2,2′-azobis(2-methylbutyronitrile), hydrogen peroxide, ammonium peroxodisulfate, potassium peroxodisulfate, dibenzoyl peroxide, di-tert-butyl peroxide, peracetic acid, diisobutyryl peroxide, cumene peroxyneodecanoate, tert-butyl peroxyneodecanoate, tert-butyl peroxypivalate, tert-amyl peroxypivalate, dipropyl peroxydicarbonate, dibutyl peroxydicarbonate, dimyristyl peroxydicarbonate, dilauroyl peroxide, 1,1,3,3-tetramethylbutyl peroxy-2-ethylhexanoate, tert-amyl peroxy-2-ethylhexylcarbonate, tert-butyl peroxyisobutyrate, 1,1-di(tert-butylperoxy)cyclohexane, tert-butyl peroxybenzoate, tert-butyl peroxyacetate, tert-butyl peroxydiethylacetate, tert-butyl peroxyisopropylcarbonate, 2,2-di(tert-butylperoxy)butane, tert-amyl hydroperoxide, 2,5-dimethyl-2,5-di(tert-butylperoxy)hexane or mixtures thereof.

18. The process as claimed in claim 14, wherein the solvent is a straight-chain or branched alkanes, alkyl-substituted aromatic solvents, water-immiscible or only partly water-miscible alcohols or ethers, water acetic acid or mixtures thereof.

19. The process as claimed in claim 18, wherein the alcohol is methanol, propanol, i-butanol n-butanol mixtures thereof or mixtures of these alcohols with water.

20. The process as claimed in claim 14, wherein the reaction temperature is 50 to 150° C.

21. An intermediate for further syntheses, a binder, a crosslinker or accelerator in the curing of epoxy resins, polyurethanes and unsaturated polyester resins, polymer stabilizer, a crop protection composition, a sequestrant, a mineral oil additive, as an anticorrosive, a washing composition, a cleaning composition or an electronic composition comprising a mixture of at least one diphosphinic acid of the formula (I) 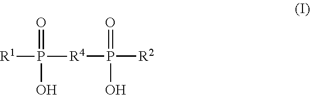
wherein
R¹, R² are H, C₁-C₁₈-alkyl, C₂-C₁₈-alkenyl, C₆-C₁₈-aryl or C₇-C₁₈-alkylaryl
R⁴ is C₁-C₁₈-alkylene, C₂-C₁₈-alkenylene, C₆-C₁₈-arylene or C₇-C₁₈-alkylarylene with at least one alkylphosphonic acid of the formula (II) 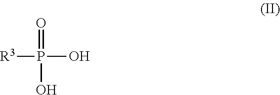
wherein
R³ is H, C₁-C₁₈-alkyl, C₂-C₁₈-alkenyl, C₆-C₁₈-aryl C₇-C₁₈-alkylaryl or mixtures thereof.

22. A flame retardant, a flame retardant for clearcoats and intumescent coatings, a flame retardant for wood and other cellulosic products, a reactive and nonreactive flame retardant for polymers, a flame-retardant polymer molding compositions, a flame-retardant for rendering polyester and pure and blended cellulose fabrics flame-retardant by impregnation, or a synergist comprising a mixture of at least one diphosphinic acid of the formula (I) 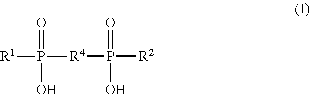
wherein
R¹, R² are H, C₁-C₁₈-alkyl, C₂-C₁₈-alkenyl, C₆-C₁₈-aryl or C₇-C₁₈-alkylaryl
R⁴ is C₁-C₁₈-alkylene, C₂-C₁₈-alkenylene, C₆-C₁₈-arylene or C₇-C₁₈-alkylarylene with at least one alkylphosphonic acid of the formula (II) 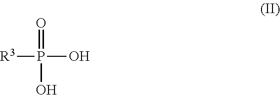
wherein
R³ is H, C₁-C₁₈-alkyl, C₂-C₁₈-alkenyl, C₆-C₁₈-aryl C₇-C₁₈-alkylaryl or mixtures thereof.

23. A flame-retardant thermoplastic or thermoset polymer molding composition, molding, film, filament or fiber comprising 0.5 to 99.5% by weight of a mixture of at least one diphosphinic acid of the formula (I) 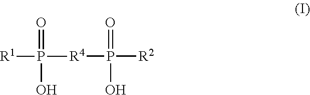
wherein
R¹, R² are H, C₁-C₁₈-alkyl, C₂-C₁₈-alkenyl, C₆-C₁₈-aryl or C₇-C₁₈-alkylaryl
R⁴ is C₁-C₁₈-alkylene, C₂-C₁₈-alkenylene, C₆-C₁₈-arylene or C₇-C₁₈-alkylarylene with at least one alkylphosphonic acid of the formula (II) 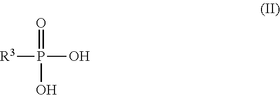
wherein
R³ is H, C₁-C₁₈-alkyl, C₂-C₁₈-alkenyl, C₆-C₁₈-aryl C₇-C₁₈-alkylaryl or mixtures thereof, 0.5 to 99.5% by weight of thermoplastic or thermoset polymer or mixtures thereof, 0 to 55% by weight of additives and 0 to 55% by weight of filler or a reinforcing material, where the sum of the components is 100% by weight.

24. A flame-retardant thermoplastic or thermoset polymer molding composition, molding, film, filament or fiber comprising 1 to 30% by weight of a mixture of at least one diphosphinic acid of the formula (I) 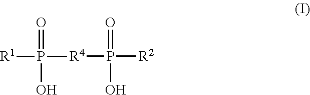
wherein
R¹, R² are H, C₁-C₁₈-alkyl, C₂-C₁₈-alkenyl, C₆-C₁₈-aryl or C₇-C₁₈-alkylaryl
R⁴ is C₁-C₁₈-alkylene, C₂-C₁₈-alkenylene, C₆-C₁₈-arylene or C₇-C₁₈-alkylarylene with at least one alkylphosphonic acid of the formula (II) 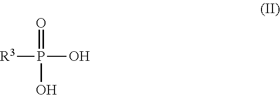
wherein
R³ is H, C₁-C₁₈-alkyl, C₂-C₁₈-alkenyl, C₆-C₁₈-aryl C₇-C₁₈-alkylaryl or mixtures thereof, 10 to 95% by weight of thermoplastic or thermoset polymer or mixtures thereof, 2 to 30% by weight of additives and 2 to 30% by weight of filler or a reinforcing material, where the sum of the components is 100% by weight.
